(19) United States
(12) Patent Application Publication
(10) Pub. No.: US 2013/0200998 A1
(43) Pub. Date: Aug. 8, 2013

(54) WIRELESS LIGHT CONTROL APPARATUS

(71) Applicant: Sheng-Min HUANG, Tainan City (TW)

(72) Inventor: Sheng-Min HUANG, Tainan City (TW)

(21) Appl. No.: 13/366,912

(22) Filed: Feb. 6, 2012

(51) Int. Cl. G08B 29/00

(52) U.S. Cl. 340/5.64

(57) ABSTRACT

A wireless light control apparatus has a signal transmitting unit and a signal receiving unit. The signal transmitting unit has a digital encoder to generate an examination code based on a transmitting key and a light driving signal. The digital encoder generates a data package based on a transmitting recognition code and the examination code. A wireless transmitter module sends out the data package. The signal receiving unit has a micro-controller having a receiving key and a receiving recognition code respectively matching the transmitting key and the transmitting recognition code. The micro-controller receives the data package through a wireless receiver module and decodes the data package to obtain the light driving signal based on the receiving key and the receiving recognition code. The repetition possibility of the recognition codes is low and the incorrect operations of the signal receiving unit decrease.

### BACKGROUND OF THE INVENTION

1. Field of the Invention

The present invention relates to a light control apparatus, and more particularly to a wireless light control apparatus.

2. Description of Related Art

A wireless light controller mainly comprises a transmitter module and a receiver module. The transmitter module is applied at a host equipment and sends out a wireless control signal. The receiver module is applied at a client equipment and electrically connected to a light display. The receiver module receives the wireless control signal and activates the light display according to the wireless control signal.

U.S. Pat. No. 6,100,801 discloses a radio controlled light bar. The transmitter module has an encoder electrically connected to a dip switch and the receiver module has a decoder electrically connected to a dip switch. The decoder is unable to decode the wireless control signal until the codes of both dip switches match each other.

The codes between different transmitter modules should be distinct to each other to meet the unity that one receiver module matches only one transmitter module. However, the dip switch as the foregoing U.S. patent disclosed has six buttons. Based on the limitation of the amount of the buttons, there are at most 2⁶ different kinds of codes.

The application of the wireless control apparatus is universal, such as an electric roller door. The 2⁶ kinds of codes are repetitively used in numerous wireless control apparatus. It is easy to understand that the 2⁶ kinds of codes are insufficient. For example, if multiple transmitter modules in a region are equipped in different host equipments but have the same codes and in approximate transmitting frequencies, one receiver module will receive all the wireless control signals from the host equipments at the same time. Therefore, the receiver module may incorrectly activate the light display.

### SUMMARY OF THE INVENTION

An objective of the present invention is to provide a wireless light control apparatus to solve the high repetition possibility of the codes.

To achieve the foregoing objective, the wireless light control apparatus comprises a signal transmitting unit and a signal receiving unit.

The signal transmitting unit comprises a digital encoder and a wireless transmitter module. The digital encoder has a transmitting key and a transmitting recognition code. The digital encoder generates an examination code based on the transmitting key and a light driving signal. The digital encoder generates a data package based on the examination code and the transmitting recognition code. The wireless transmitter module has an antenna and is electrically connected to the digital encoder to receive the data package from the digital encoder and send out the data package.

The signal receiving unit comprises a wireless receiver module, a micro-controller and a power circuit. The wireless receiver module has an antenna to receive the data package from the wireless transmitter module. The micro-controller has a receiving key and a receiving recognition code matching the transmitting key and the transmitting recognition code of the digital encoder. The micro-controller is electrically connected to the wireless receiver module to receive and decode the data package to obtain the light driving signal based on the receiving recognition code and the receiving key. The power circuit is electrically connected to the wireless receiver module and the micro-controller to provide a working voltage.

According to the wireless light control apparatus in accordance with the present invention, the kinds of codes are no longer restrained from the buttons of the dip switch. The repetition possibility of the recognition code hugely decreases. So the incorrect operations of the signal receiving unit can be reduced.

In addition, the micro-controller can have a registry button. When the registry button is activated, the micro-controller receives the data package through the wireless receiver module and takes the transmitting recognition code contained in the data package as the receiving recognition code. Because the micro-controller of the signal receiving unit automatically registers the receiving recognition code, users do not manually adjust the recognition codes. Therefore, the circuit structure in accordance with the present invention is simple and is easy to practice. The convenience is improved.

### BRIEF DESCRIPTION OF THE DRAWINGS

FIG. 1 is a circuit block diagram of an embodiment in accordance with the present invention;

FIG. 2 is a detailed circuit diagram of a signal transmitting unit of an embodiment in accordance with the present invention; and

FIG. 3 is a detailed circuit diagram of a signal receiving unit of an embodiment in accordance with the present invention.

### DETAILED DESCRIPTION OF THE PREFERRED EMBODIMENT

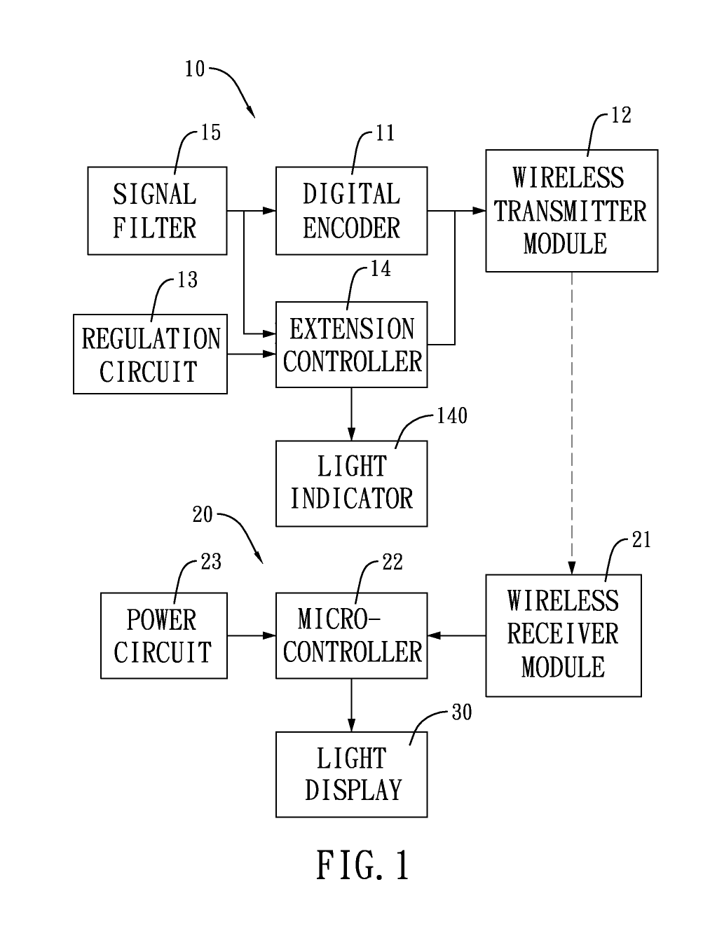

With reference to FIG. 1, a block diagram of an embodiment in accordance with the present invention is shown. The embodiment comprises a signal transmitting unit 10 and a signal receiving unit 20.

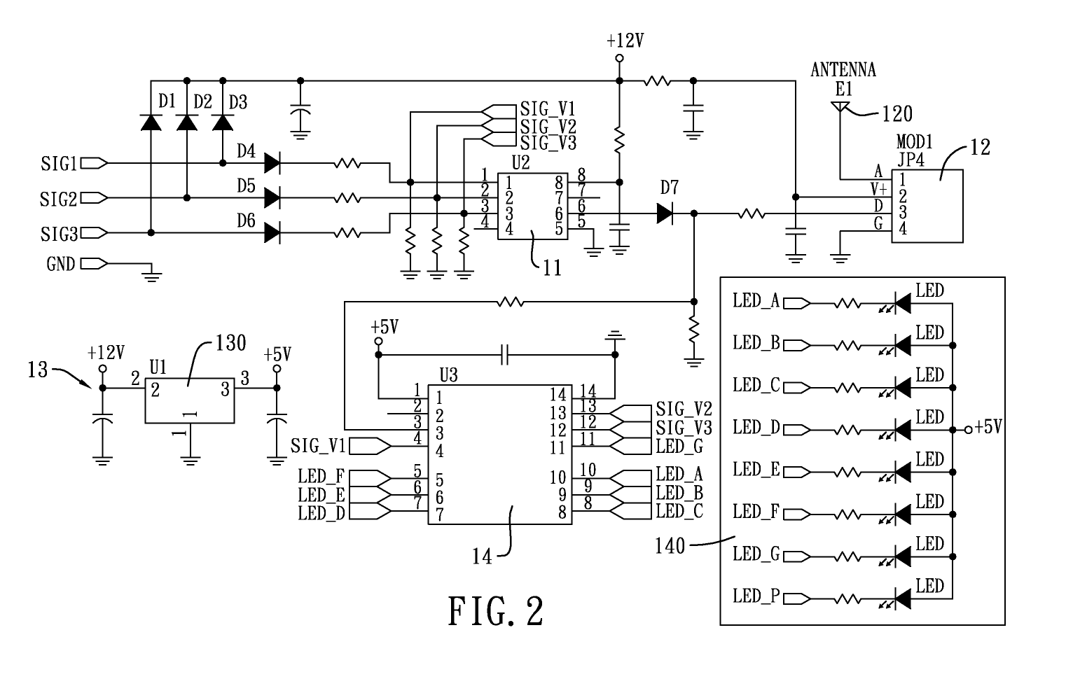

With reference to FIG. 2, a detailed circuit diagram of the signal transmitting unit 10 is shown. The signal transmitting unit 10 comprises a digital encoder 11 and a wireless transmitter module 12.

The digital encoder 11 has a transmitting key, a transmitting recognition code, multiple inputs and multiple outputs. The transmitting recognition code is built in the digital encoder 11. The inputs are applied to connect to a host equipment to receive a light driving signal. The digital encoder 11 can obtain a working voltage from the light driving signal. The inputs of the digital encoder 11 can be electrically connected to multiple signal filters 15 to filter noises of the light driving signal. When the digital encoder 11 receives the light driving signal, the digital encoder 11 generates an examination code based on the transmitting key and the light driving signal. Then the digital encoder 11 generates a data package based on the transmitting recognition code and the examination code. In this embodiment, a bit length of the data package is 64-bits. The data package includes the transmitting recognition code of 32-bits and the examination code of 32-bits. The wireless transmitter module 12 has an input and an antenna 120. The input of the wireless transmitter module 12 is electrically connected to the output of the digital encoder 11 to receive the data package from the digital encoder 11. The antenna 120 is applied to send out the data package in radio waves. The wireless transmitter module 12 may be composed of multiple electric components. In this embodiment, the wireless transmitter module 12 is a surface acoustic wave radio frequency integrated circuit (SAW RFIC) with a locked communicating channel at 434 MHz.

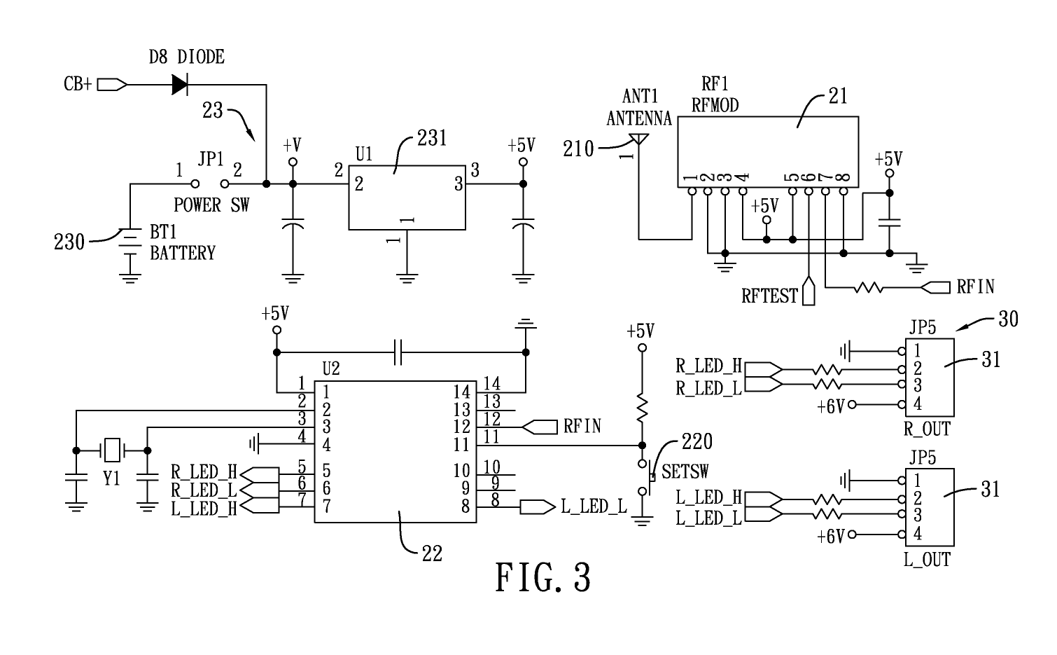

With reference to FIG. 3, a detailed circuit diagram of the signal receiving unit 20 is shown. The signal receiving unit 20 comprises a wireless receiver module 21, a micro-controller 22 and a power circuit 23.

The wireless receiver module 21 has an antenna 210 to receive the data package transmitted from the signal transmitting unit 10. In this embodiment, the wireless receiver module 21 is a radio frequency integrated circuit (RFIC) with a locked communicating channel at 434 MHz. Because the communicating channel of the wireless receiver module 21 and the wireless transmitter module 12 are established in a manufacturing process and are in the same frequency, users do not adjust the communicating channels manually. Moreover, the communication ability of the receiver module and the transmitter module are hardly affected by various factors such as humidity and temperature conditions. Therefore, the sensitivity of the wireless receiver module 21 is improved.

The micro-controller 22 is electrically connected to the wireless receiver module 21 to receive the data package and has a registry button 220. When the registry button 220 is activated, the micro-controller 22 receives the data package through the wireless receiver module 21 in the air. The micro-controller 22 registers and stores the transmitting recognition code of the data package and takes the transmitting recognition code as a receiving recognition code. With the receiving recognition code, the micro-controller 22 matches the digital encoder 11. In addition, the micro-controller 22 has a receiving key matching the transmitting key of the digital encoder 11. If the micro-controller 22 has established the receiving recognition code, the micro-controller 22 starts to receive multiple following data packages and determines whether the following received data packages match the receiving recognition code or not. If the following received data packages match the receiving recognition code, the micro-controller 22 will decode the examination code of the data packages to obtain the light driving signal by the receiving key.

The power circuit 23 is electrically connected to the wireless receiver module 21 and the micro-controller 22 to provide a working voltage. In this embodiment, the power circuit 23 comprises a regulator 231. The regulator 231 has an input electrically connected to a battery 230 or an outer power supply. The regulator 231 regulates a voltage of the battery 230 or the outer power supply to the working voltage, such as a +5V working voltage.

The micro-controller 22 of the signal receiving unit 20 can be electrically connected to a light display 30. The light display 30 comprises multiple light emitting devices 31, such as LEDs. The micro-controller 22 provides the light driving signal to the light emitting devices 31 to activate the light emitting devices 31.

The signal transmitting unit 10 can further comprise a regulation circuit 13 and an extension controller 14. The extension controller 14 is applied to provide an additional function.

The extension controller 14 has multiple inputs and outputs. The inputs of the extension controller 14 are electrically connected to the inputs of the digital encoder 11 to receive the light driving signal. One output of the extension controller 14 is electrically connected to the input of the wireless transmitter module 12. The rest outputs of the extension controller 14 are electrically connected to a light indicator 140, such as a seven-segment display. The extension controller 14 is applied to activate the light indicator 140 and then the light indicator 140 dynamically or statically displays a light status. For example, the light indicator 140 displays “1” to represent a braking light and displays “2” to represent a turn-left light.

The extension controller 14 generates an extension control signal. The functions of the extension control signal are different from the functions of the light driving signal. When the digital encoder 11 generates a data package, the extension controller 14 detects an end bit of the data package. Then the extension controller 14 combines the extension control signal with the data package after the end bit of the data package. Hence, the wireless transmitter module 12 can successively send out the extension control voltage after sending out the data package.

The regulation circuit 13 is electrically connected to the extension controller 14 to provide a working voltage. In this embodiment, the regulation circuit 13 comprises a regulator 130. The regulator 130 is electrically connected to the host equipment and regulates the light driving signal to the working voltage. For example, the regulator 130 regulates a +12V voltage to a +5V voltage.

The digital encoder 11 and the extension controller 14 respectively generate the data package and the extension control signal. The wireless transmitter module 12 receives the data package with the extension control signal and then sends out the data package with the extension control signal. The wireless receiver module 21 receives the data package with the extension control signal from the digital encoder 11 and the extension controller 14. The micro-controller 22 receives and decodes the received data package to obtain the examination code and the extension control signal by the receiving recognition code. Then the micro-controller 22 decodes the examination code to obtain the light driving signal by the receiving key. Hence, the micro-controller 22 activates the light display 30 to show different lighting statuses according to the light driving signal and the extension control signal.

An operating instance in accordance with the present invention is described below. The signal transmitting unit 10 is applied at a host equipment, such as a truck. The signal receiving unit 20 and the light display 30 are applied at a client equipment, such as a towed trailer connected behind the truck. The signal transmitting unit 10 is electrically connected to a light controller that activates the turning lights and the braking lights of the truck. The signal receiving unit 20 is electrically connected to a light bar of the towed trailer. The light display 30 can be mounted on a tail of the towed trailer.

If the truck brakes, the light controller of the truck will generate a light driving signal standing for the braking condition. The digital encoder 11 encodes the light driving signal to a data package based on the receiving recognition code and the transmitting key. The wireless transmitter module 12 sends out the data package. The micro-controller 22 receives the data package via the wireless receiver module 21 and decodes the data package to obtain the light driving signal based on the receiving recognition code and the receiving key to activate the light display 30. Therefore, the appearance of the light display 30 stands for the braking condition.

The operating instance mentioned above is just an illustrative example. Actually, users can set the signal transmitting unit 10, the signal receiving unit 20 and the light display 30 at any equipment of interest to them.

Above all, the transmitting recognition code and the receiving recognition code are digital codes. To write the transmitting recognition code in the digital encoder, the digital encoder 11 can be electrically connected to a computer via a burning recorder. The computer writes the transmitting recognition code to the digital encoder 11 through the burning recorder. Because the transmitting recognition code is a 32-bit digital data, a transmitting recognition code of interest can be selected from 2³² kinds of transmitting recognition codes. A repetition possibility of the transmitting recognition codes is much lower than the repetition rate of the prior art with 2⁶ kinds of transmitting recognition codes. Therefore, the interference between the signal transmitting units 10 decreases.

The micro-controller 22 of the signal receiving unit 20 receives the data package from the signal transmitting unit 10 in the air and then registers and stores the transmitting recognition code as the receiving recognition code through the registry button 220. Users can match a signal receiving unit 20 to a signal transmitting unit 10 of interest. The micro-controller 22 is able to automatically register the receiving recognition code as long as the registry button 220 is activated. Additionally, the registered receiving recognition code of the micro-controller 22 is erasable. The registry button 220 is also applied to erase the registered receiving recognition code. If the registered receiving recognition code of a signal receiving unit 20 is erased, such signal receiving unit 20 is able to be built with a new receiving recognition code from a signal transmitting unit 10 via the same registry procedure mentioned above. Therefore, the wireless light control apparatus in accordance with the present invention is applied to multiple usages.

What is claimed is:

1. A wireless light control apparatus comprising:
a signal transmitting unit comprising:
a digital encoder having a transmitting key and a transmitting recognition code, generating an examination code based on the transmitting key and a light driving signal and generating a data package based on the examination code and the transmitting recognition code; and
a wireless transmitter module having an antenna and electrically connected to the digital encoder to receive the data package from the digital encoder and send out the data package; and
a signal receiving unit comprising:
a wireless receiver module having an antenna to receive the data package from the wireless transmitter module;
a micro-controller having a receiving key and a receiving recognition code respectively matching the transmitting key and the transmitting recognition code of the digital encoder and electrically connected to the wireless receiver module to receive and decode the data package to obtain the light driving signal based on the receiving recognition code and the receiving key; and
a power circuit electrically connected to the wireless receiver module and the micro-controller to provide a working voltage.

2. The wireless light control apparatus as claimed in claim 1, wherein
the micro-controller has a registry button; and
when the registry button is activated, the micro-controller receives the data package through the wireless receiver module and takes the transmitting recognition code contained in the data package as the receiving recognition code.

3. The wireless light control apparatus as claimed in claim 2 further comprising an extension controller electrically connected between the digital encoder and the wireless transmitting module, wherein
the extension controller generates an extension control signal and combines the extension control signal with the data package after an end bit of the data package; and
the extension control signal has functions different from those of the light driving signal.

4. The wireless light control apparatus as claimed in claim 3, wherein the extension controller is electrically connected to a light indicator to activate the light indicator based on the light driving signal.

5. The wireless light control apparatus as claimed in claim 1, wherein the micro-controller is electrically connected to a light display and the light display is activated based on the light driving signal.

6. The wireless light control apparatus as claimed in claim 2, wherein the micro-controller is electrically connected to a light display and the light display is activated based on the light driving signal.

7. The wireless light control apparatus as claimed in claim 3, wherein the micro-controller is electrically connected to a light display and the light display is activated based on the light driving signal and the extension control signal.

8. The wireless light control apparatus as claimed in claim 4, wherein the micro-controller is electrically connected to a light display and the light display is activated based on the light driving signal and the extension control signal.

9. The wireless light control apparatus as claimed in claim 1, wherein the power circuit has a regulator applied to provide the working voltage.

10. The wireless light control apparatus as claimed in claim 2, wherein the power circuit has a regulator applied to provide the working voltage.

11. The wireless light control apparatus as claimed in claim 3, wherein the power circuit has a regulator applied to provide the working voltage.

12. The wireless light control apparatus as claimed in claim 4, wherein the power circuit has a regulator applied to provide the working voltage.

13. The wireless light control apparatus as claimed in claim 9, wherein the regulator has an input electrically connected to a battery.

14. The wireless light control apparatus as claimed in claim 10, wherein the regulator has an input electrically connected to a battery.

15. The wireless light control apparatus as claimed in claim 11, wherein the regulator has an input electrically connected to a battery.

16. The wireless light control apparatus as claimed in claim 12, wherein the regulator has an input electrically connected to a battery.

17. The wireless light control apparatus as claimed in claim 1, wherein a bit length of the data package generated from the digital encoder is 64-bits; and
the data package includes the transmitting recognition code of 32-bits and the examination code of 32-bits.

18. The wireless light control apparatus as claimed in claim 2, wherein a bit length of the data package generated from the digital encoder is 64-bits; and
the data package includes the transmitting recognition code of 32-bits and the examination code of 32-bits.

19. The wireless light control apparatus as claimed in claim 3, wherein a bit length of the data package generated from the digital encoder is 64-bits; and
the data package includes the transmitting recognition code of 32-bits and the examination code of 32-bits.

20. The wireless light control apparatus as claimed in claim 4, wherein a bit length of the data package generated from the digital encoder is 64-bits; and
the data package includes the transmitting recognition code of 32-bits and the examination code of 32-bits.
